(19) United States
(12) Patent Application Publication
(10) Pub. No.: US 2020/0136965 A1
(43) Pub. Date: Apr. 30, 2020

(54) ROBUSTNESS ENHANCING ROUTER FOR CONTROLLER AREA NETWORKS

(71) Applicant: Ten-D Energies, Inc., Mercer Island, WA (US)

(72) Inventors: Michael Gray, Redmond, WA (US); Jerry Gibson, Mercer Island, WA (US)

(21) Appl. No.: 16/173,872

(22) Filed: Oct. 29, 2018

(51) Int. Cl. H04L 12/721

(52) U.S. Cl. CPC H04L 45/72; H04L 2012/40215

(57) ABSTRACT

A method for routing CAN or CAN-FD frames by receiving at least a portion of an incoming frame; applying a programmed policy to determine to which of one or more destination interfaces the incoming frame should be forwarded, at any time when the policy can be evaluated against the incoming frame, even if before the incoming frame is received in its entirety; and initiating queuing or immediate transmission of the received frame on the destination interfaces, possibly before the incoming frame has been received in its received entirety. The method may include applying a programmed policy to the incoming frame which includes a rate limit, specifying the rate at which the policy may forward frames. And may further include enacting a frame modification during the reception or transmission, with the modification further encoded within the programmed policy modification of the CAN frame as it is received or transmitted.

### BACKGROUND OF THE INVENTION

### Field of the Invention

The present invention is directed generally to routers for controller area networks.

### Description of the Related Art

Controller Area Networks (such as those implemented with the CAN and CAN-FD bus technologies) are used to interconnect sensors, actuators, controllers, monitoring, and diagnostic components in industrial robotics, electronic automotive systems, and other fields requiring electronic control and monitoring. While the electrical and protocol specifications of CAN and CAN-FD busses are designed to ensure robust networks when devices are properly operating, the devices themselves may malfunction, have their security or integrity compromised, or may have even been connected to the network with malicious intent. Moreover, devices essential to operational or safety-critical processes are often interconnected with less robust monitoring and diagnostic equipment. This may be due to an unavoidable interface with non-secure or unreliable general-purpose computing hardware, the proliferation of access to wireless or public computer networks, or budgetary restrictions that extend the lifecycle of shared or legacy hardware.

### BRIEF DESCRIPTION OF THE SEVERAL VIEWS OF THE DRAWING(S)

FIG. 1 is an illustration of the interconnection of components in a preferred embodiment of the invention.

FIG. 2 is a flowchart illustrating the combined logic performed by the preferred embodiment of the invention.

### DETAILED DESCRIPTION OF THE INVENTION

The invention may be embodied in a method where CAN and CAN-FD frames are matched against a routing policy at any time during and after reception, allowing re-transmission of the frame (or a version modified by the routing policy) as soon as the routing policy can soundly be evaluated, and without enforcing the requirement that a frame first be received in its entirety. Routing policy may encompass the rate of reception or transmission, as well as the source and content of the frame itself. If required, the frame may be sent to a local processing device within the router, rather than a CAN interface, when more complex processing is required to route or respond to the frame. Furthermore, one or more interfaces of the router may be designated as passive taps, wherein frames received on the passive taps cannot be forwarded to other interfaces, but frames received on other interfaces may be forwarded to a passive tap.

The invention may be embodied in a system for routing CAN and CAN-FD frames, comprising a plurality of CAN or CAN-FD interfaces, a non-reconfigurable and non-reprogrammable routing element, a non-reconfigurable and non-reprogrammable policy deciding element, and a policy store. The policy store may further be made non-reprogrammable, if required.

The invention may be embodied in a method for responding to request-response protocols like OBD-II in a CAN or CAN-FD router. The response is originated by the router itself, and not the target OBD-II device. The data in the response may be populated by a proxy request-response transaction sent on behalf of the original requestor, previously-received cached data, or a fixed-payload described in the router's policy.

A preferred embodiment of a router in accordance with the invention enhances the robustness of controller area networks (such as those built on the CAN and CAN-FD bus technologies). The preferred embodiment combines a variety of techniques that improve system robustness, including resilience with malfunctioning, compromised, or malicious bus nodes. This is only one such embodiment of claimed methods and apparatuses; other embodiments based on differing logic, processor, and/or memory technologies, and routers making use of some subset of the claimed subject matter, are also possible.

The router enhances the robustness of controller area networks by regulating the types of messages, message content, message rates, and message flow direction between CAN or CAN-FD busses interconnected by the router. Messages may be routed as soon as the configured routing policy can be evaluated, meaning the message does not need to be received in its entirety before transmission commences on the destination interface(s). This prevents the router from disrupting latency and jitter sensitive communications.

To further enhance robustness, requests issued as a part of a request-response protocol such as OBD-II (a commonly used automotive diagnostic protocol based on CAN) may be serviced by the router itself, without generating traffic, or by generating carefully controlled traffic, on the target bus. The data returned as a response may be obtained by the router by proxy request, from cached data previously received on another interface, or with a fixed response configured in the policy. Request-response proxying further enhances robustness by controlling the content, rate, and type of the requests. In the case where cached data or fixed responses may be returned to the requesting device, request traffic is eliminated entirely on the target bus.

Furthermore, one or more interfaces may be designated as passive taps, whereby traffic originating on a passive tap is never forwarded to another interface. Request-response proxying with data cached from another interface or with fixed responses allows compatibility with OBD-II and other request-response protocols, but without violating this passive tap property. Passive taps allow untrusted devices (perhaps temporarily connected during to regulatory inspection or service) and vulnerable devices (like those exposed to a wireless network or internet connection) to connect to sensitive networks, such as a vehicle powertrain or electronic control unit.

In the preferred embodiment, alteration of routing functionality by rogue, compromised, or malfunctioning devices is prevented by implementing routing/queuing, proxying, and policy lookup processes in a non-reconfigurable and non-reprogrammable way. While there are many well-known techniques to accomplish this, those that are particularly suitable include the use of fixed circuit configuration, fixed-function integrated circuits (such as ASICs and non-reconfigurable gate arrays), read-only-memories for the storage of configuration data, firmware and software, memories rendered one-time-programmable, or memories rendered programmable only at the time of manufacture. If the application allows, routing policy may further be stored in similar non-reconfigurable logic, read-only-memory or memories rendered one-time-programmable or programmable only at the time of manufacture.

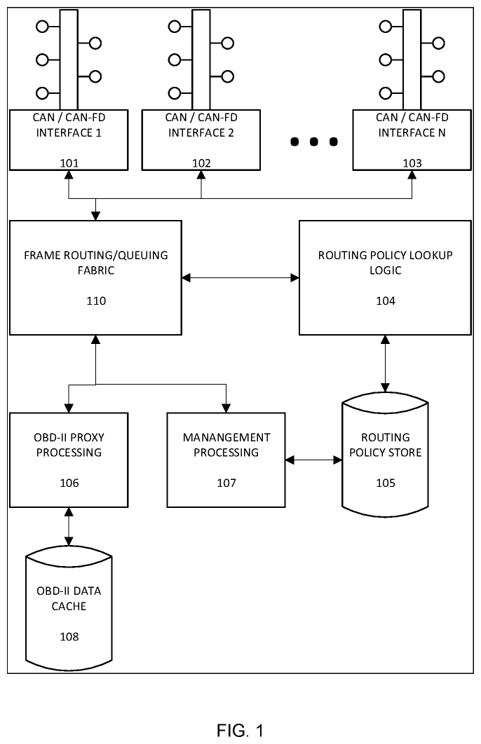

FIG. 1 illustrates the preferred embodiment of the invention, however, it represents just one of possible embodiments of the invention. The invention includes any electronic embodiment, regardless of processing, logic, memory, or other implementing technology.

At least two CAN or CAN-FD interfaces 101-103 are interconnected by a routing/queuing fabric 110, capable of switching a message (herein referred to as a CAN frame, the physical-layer embodiment of a CAN message) between CAN networks with arbitrary delay, such that frame forwarding can begin as soon as routing policy can successfully be evaluated against an incoming message. The queueing portion of the fabric allows delaying a message until a policy matches the incoming message (which perhaps could require buffering the entire message, if no policy matches until the end), or if the target interface is busy after a policy decision can be made.

The frame routing/queuing fabric 110 connects to a routing policy lookup logic 104 to search the routing policy encoded in a routing policy store 105. The routing policy store may be comprised of memory organized for random access (a “RAM” or linearly-addressable “ROM”), content addressability (a “CAM” or cache), or other organization, provided that the lookup logic 104 has the ability to look up a policy while incoming CAN frames are being received. In some cases (such as the use of RAM), known data structures that allow for fast lookup may result in a more efficient implementation.

The routing policy store 105 may encode rules for frames based on any subset of a frame or the frame in its entirety. In many cases, only a specification of the incoming bus, the CAN frame header (which encodes a CAN-ID describing the payload of a frame), or some initial portion of the header, needs to be specified by the rule. In others, it may be necessary to examine the entire CAN frame or some portion thereof to determine which policy applies. Rules encoded in the routing policy store 105 specify which interface(s) the matched frame should be forwarded to, any modifications that should be made to the frame during forwarding, and whether the frame should be forwarded to an OBD-II proxy processor 106 or a management processor 107. The policy may also specify an incoming or outgoing message rate range in which the rule is active.

The frame routing/queuing fabric 103 is further connected to the OBD-II proxy processor 106 that can receive OBD-II requests and potentially reply without generating traffic, or by generating carefully controlled traffic, on the target bus. Data in the reply is populated using cached data received on the target bus at an earlier time, a fixed reply encoded in the routing policy, or a proxy-request made by the OBD-II proxy processor on behalf of the incoming request. The cached data in an OBD-II data cache 108 may be updated based on responses to these proxy requests, or responses passively observed on the target bus. As with all elements in the preferred embodiment, processing may commence as soon as appropriate, and before an entire CAN frame has been received on the incoming interface.

The frame routing/queuing fabric 103 is further connected to a management processor 107 that can perform arbitrary, firmware-defined computations in response to CAN frames directed at it by the frame routing fabric. These include, but are not limited to the recording of statistics, performing security or functionality audits, transmitting additional frames, and updating the routing policy store 105 to include information ‘learned’ by observing an active bus. As with all elements in the preferred embodiment, processing may commence as soon as appropriate, and before an entire CAN frame has been received on the incoming interface.

The CAN or CAN-FD interfaces 101-103, frame routing/queuing fabric 110, routing policy lookup logic 104, OBD-II proxy processing 106, management processing 107, routing policy store 105, and OBD-II data cache 108 may be implemented with a variety of technologies. While their function is logically distinct, they could be implemented within the same device or technology, each function either sharing space, time, or some combination with the other functions. In the preferred embodiment, the logical function of these elements is fixed through the use of non-reconfigurable electronics. While many techniques accomplishing a non-reconfigurability property are well known, particularly suitable techniques include the use of fixed circuit configuration, fixed-function integrated circuits (such as ASICs and non-reconfigurable gate arrays), read-only-memories for the storage of configuration, firmware and software, memories rendered one-time-programmable, or memories rendered programmable only at the time of manufacture. In addition, when the application allows, the routing policy store 105 may further be rendered non-reconfigurable through the same techniques.

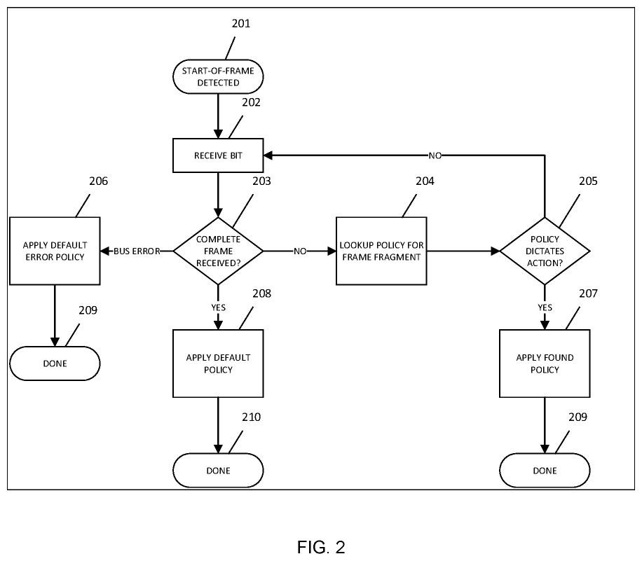

FIG. 2 illustrates the combined logic implemented by the preferred embodiment as a flowchart. Note that this is from the perspective a single incoming CAN frame, of which multiple may be simultaneously received.

For each CAN frame, a start-of-frame signal is received 201, initiating the process. A bit is received 202 (the start-of-frame itself constitutes one bit). All bits received in a message thus far are used to search 204 the routing policy store 105. If a message has not yet been received in its entirety 203, and the policy does not dictate an action 205, no immediate action is taken and further bits are received 202. If a message has been received in its entirety 203, before a policy has been applied, a default policy 208 is applied. In the case of an error (either detected by the CAN or CAN-FD interface, or signaled by another bus node), an error policy is applied 206. The error policy encodes the action that should be taken upon detection of an error. Application of a policy denotes the execution of one or more actions applied to message on the frame routing/queuing fabric 110, OBD-II proxy processor 106, or the management processor 105. After applying a policy, the process is deemed done 209-211.

Note that preferred embodiment attempts to find a matching routing policy on the reception of each new bit. The invention encompasses routers that may search for matching policies less frequently, such as after the header or CAN-ID of an incoming frame is received, but not necessarily after each received bit.

The invention claimed is:

1. A method for routing CAN or CAN-FD frames, the method comprising:
receiving at least a portion of an incoming frame;
applying a programmed policy to determine to which of one or more destination interfaces the incoming frame should be forwarded, at any time when the policy can be evaluated against the incoming frame, even if before the incoming frame is received in its entirety; and
initiating queuing or immediate transmission of the received frame on the destination interfaces, possibly before the incoming frame has been received in its received entirety.

2. The method of claim 1, further comprising:
applying a programmed policy to the incoming frame which includes a rate limit, specifying the rate at which the policy may forward frames.

3. The method of claim 2, further comprising:
enacting a modification of the frame during the reception or transmission described in claim 1, with the modification further encoded within the programmed policy modification of the CAN frame as it is received or transmitted possibly before it has been received or transmitted in its entirety.

4. The method of claim 3, further comprising:
the policy-specified optional redirection of a received or transmitted frame to a local processing device, wherein the internal processing device performs further processing in response to said frame, such as recording statistics, storing information for later use, transmitting a frame in response, further modification of said frame for retransmission, and/or modification of the forwarding policy to be applied in future routing.

5. The method of claim 4, further comprising:
the restriction of one or more interfaces as passive taps, wherein frames received on the passive taps will not be forwarded to other interfaces.

6. A system for routing CAN or CAN-FD frames, the system comprising:
a plurality of CAN or CAN-FD interfaces;
a means by which frame routing decisions can be made, wherein said means is rendered immutable by the use of electronics in a fixed configuration, instructions stored in memory and rendered read-only after the time of installation, and/or configuration data stored in memory and rendered read-only after the time of installation;
a means by which frame routing decisions can be executed, wherein said means is rendered immutable by the use of electronics in a fixed configuration, instructions stored in memory rendered read-only after the time of installation, and/or configuration data stored in memory rendered read-only after the time of installation; and
a means by which frame routing policy can be stored, to be used by said means for making frame routing decisions.

6. The system of claim 6, further comprising:
the restriction of the frame routing policy to be stored in a memory that has been rendered immutable by the use of electronics in a fixed configuration, instructions stored in memory rendered read-only after the time of installation, and/or configuration data stored in memory rendered read-only after the time of installation.

8. A method for responding to request-response protocols such as OBD-II in a CAN or CAN-FD router, that method comprising:
receiving a request frame on an incoming interface;
interpreting the request frame within the router; and
originating a reply frame from within the router.

9. The method of claim 8, further comprising:
the generation of the reply frame using data cached within the router's memory.

10. The method of claim 9, further comprising:
the generation of the reply frame data based on a request-by-proxy transaction originated by the router on an interface distinct from the originating interface.

11. The method of claim 10, further comprising:
the restriction of the maximum number of requests by proxy that may be generated by the router in a given timeframe, wherein said restriction is encoded in the router's policy.

12. The method of claim 11, further comprising:
the generation of the reply frame data based on fixed response configured into the router's policy.
